(19) United States
(12) Patent Application Publication
(10) Pub. No.: US 2022/0062792 A1
(43) Pub. Date: Mar. 3, 2022

(54) PHASE SEPARATOR AND PHASE SEPARATION SYSTEM INCLUDING THE SAME AND PHASE SEPARATION METHOD

(71) Applicant: KABUSHIKI KAISHA KOBE SEIKO SHO (KOBE STEEL, LTD.), Hyogo (JP)

(72) Inventor: Akira MATSUOKA, Kobe-shi (JP)

(73) Assignee: KABUSHIKI KAISHA KOBE SEIKO SHO (KOBE STEEL, LTD.), Hyogo (JP)

(21) Appl. No.: 17/403,528

(22) Filed: Aug. 16, 2021

(30) Foreign Application Priority Data
Sep. 1, 2020 (JP) 2020-146837

(51) Int. Cl. B01D 17/04; B01D 17/02

(52) U.S. Cl. CPC B01D 17/04; B01D 17/0214

(57) ABSTRACT

Provide is a phase separator having a phase separation function and a function of promoting mutual contact between the first liquid and the second liquid in a compact structure. The phase separator includes a main body container, a partition member, and a mixed-liquid introduction part. The body container defines a storage space for the mixed liquid. The partition member partitions the storage space into a plurality of horizontally arranged spaces including a mutual contact space allowing the first and second liquids to flow vertically while being in contact with each other, and a phase separation space for separating the mixed liquid into a first liquid phase and a second liquid phase. The mixed-liquid introduction part allows introduction of the mixed liquid through the mixed-liquid introduction part to make the mixed liquid flow from the introduction end toward the discharge end of the partition member through the mutual contact space.

### TECHNICAL FIELD

The present invention relates to a phase separator, a phase separation system including the same, and a phase separation method.

### BACKGROUND ART

A mixed liquid discharged from an extraction processing apparatus or the like is separated by a phase separator if necessary. The mixed liquid, if containing a first liquid and a second liquid that have different specific gravities, can be separated into a first liquid phase formed of the first liquid and a second liquid phase formed of the second liquid by being introduced into the phase separator and allowed to stand still therein with utilization of the above-described difference between the specific gravities.

As an apparatus including such a phase separator, U.S. Pat. No. 6,119,029 discloses a solvent extraction apparatus including a mixer section and a settler section. The mixer section stirs and mixes an organic solvent and an aqueous solution to produce a mixed liquid. The settler section, which corresponds to the phase separator, lets the mixed liquid having been generated in the mixer section stand still in the settler section. Because of the difference between the specific gravity of the organic solvent and the specific gravity of the aqueous solution in the mixed liquid, the mixed liquid left standing in the settler section can be separated vertically into an organic solvent phase and an aqueous solution phase.

The conventional phase separator, however, has only a function of receiving a mixed liquid and letting it to be brought into phase-separation like the settler section disclosed in U.S. Pat. No. 6,119,029, thus having no function of promoting mutual contact between the first liquid and the second liquid that are contained in the mixed liquid to supplement an operation by the contact, such as extraction. If having such a contact promoting function, the phase separator will be able to compensate for a shortage of mutual contact between the first liquid and the second liquid, which shortage may be caused by an accident (e.g., a distribution failure or a variation of a component) in an upstream device provided upstream of the phase separator (e.g., an extraction device). If the mutual contact between the first liquid and the second liquid is promoted in the phase separator, it allows, alternatively, the upstream apparatus to have reduced size, in view of the promotion.

With respect to the above point, the settler section described in Patent Document 1 also allows the raw material fluid and the extractant to come into mutual contact at the interface between the raw material fluid and the extractant, but the contact area is so small that the action due to such contact, such as extraction, cannot be expected. In other words, providing sufficient inter-contact between separated liquid phases in a conventional phase separator requires enormous contact area, which involves a remarkable enlargement of the entire phase separator.

### SUMMARY OF INVENTION

It is an object of the present invention to provide the follows: a phase separator having both a function of bringing a mixed liquid containing a first liquid and a second liquid into phase separation and a function of promoting mutual contact between the first liquid and the second liquid in a compact structure; a phase separation system including the same; and a phase separation method using the phase separator. Provided is a phase separator that receives a mixed liquid to bring the mixed liquid into phase separation, the mixed liquid containing a first liquid and a second liquid that are capable of forming a first liquid phase and a second liquid phase, respectively, the first liquid being immiscible with the second liquid and having a larger specific gravity than a specific gravity of the second liquid. The phase separator includes a main body container, a partition member, a mixed-liquid introduction part, a first lead-out part, and a second lead-out part. The body container defines a storage space for storing the mixed liquid. The partition member is disposed inside the main body container so as to partition the storage space into a plurality of spaces arranged horizontally. The plurality of spaces include a mutual contact space allowing the first liquid and the second liquid to flow vertically while being in contact with each other in the mutual contact space, and a phase separation space for separating the mixed liquid into the first liquid phase formed of the first liquid and the second liquid phase formed of the second liquid. The mixed-liquid introduction part allows the mixed liquid to be introduced into the mutual contact space through the mixed-liquid introduction part so as to make the mixed liquid flow from an introduction end that is an end selected from an upper end and a lower end of the partition member to a discharge end that is an end opposite to the introduction end selected from the upper end and the lower end of the partition member. The first lead-out part is provided at a height position where the first liquid phase separated in the phase separation space is present to allow the first liquid forming the first liquid phase to be led out from the main body container through the first lead-out part. The second lead-out part is provided at a height position where the second liquid phase separated in the phase separation space is present to allow the second liquid forming the second liquid phase to be led out from the main body container through the second lead-out part. The storage space is formed with a discharge-side circulation flow path that allows the mixed liquid discharged from the discharge end of the partition member to transfer to the phase separation space, and an introduction-side circulation flow path that allows a liquid forming a liquid phase that is present at the height position of the introduction end out of the first liquid phase and the second liquid phase that are separated in the phase separation space to be introduced into the mutual contact space through the introduction end.

### BRIEF DESCRIPTION OF DRAWINGS

FIG. 1 is a flow sheet showing a phase separation system according to a first embodiment of the present invention;

FIG. 2 is a flow sheet showing a phase separation system according to a comparative example;

FIG. 3 is a flow sheet showing a phase separation system according to a second embodiment of the present invention; and

FIG. 4 is a flow sheet showing a phase separation system according to a third embodiment of the present invention.

### DESCRIPTION OF EMBODIMENTS

Hereinafter, preferred embodiments of the present invention will be described with reference to the drawings.

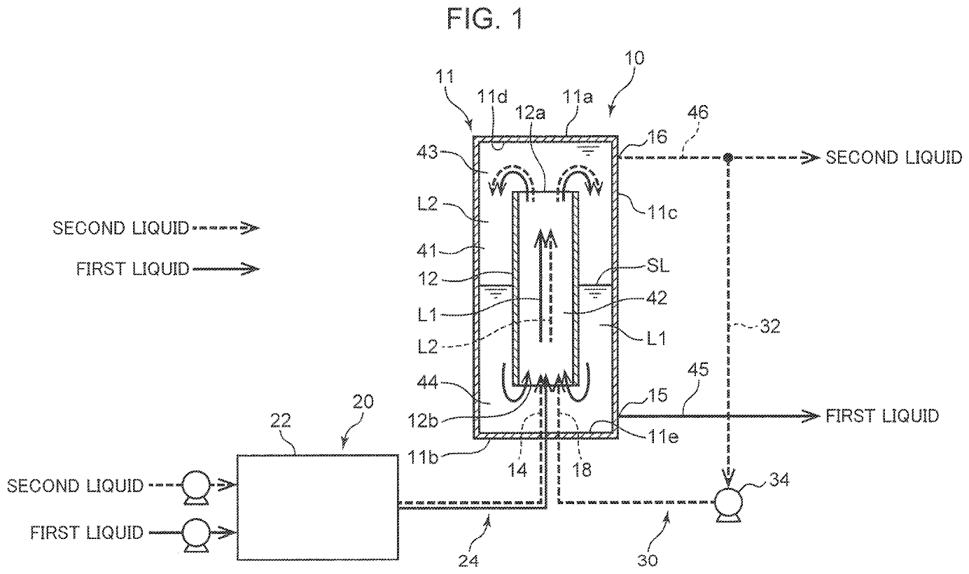

FIG. 1 shows a phase separation system according to a first embodiment of the present invention. The phase separation system includes a phase separator 10, a mixed-liquid supply device 20, and a second-liquid return device 30.

The phase separator 10 is configured to receive a mixed liquid supplied from the mixed-liquid supply device 20 to bring the mixed liquid into phase separation. The mixed liquid contains a first liquid L1 and a second liquid L2. The first liquid L1 and the second liquid L2 are immiscible with each other, and the first liquid L1 has a specific gravity larger than the specific gravity of the second liquid L2. The phase separator 10 separates the mixed liquid into a first liquid phase formed of the first liquid. L1 and a second liquid phase formed of the second liquid L2 by utilization of the difference between the specific gravity of the first liquid L1 which is a heavy liquid and the specific gravity of the second liquid L2 which is a light liquid. FIG. 1 shows respective arrows of thick solid lines and thick dotted lines that indicate the flow of the first liquid L1 and the flow of the second liquid L2, respectively.

In addition to the function of the above-described phase separation, the phase separator 10 further has a function of promoting mutual contact between the first liquid L1 and the second liquid L2 in the phase separator 10. The purpose of this mutual contact, which is not limited in the present invention, is the below-described complementation of an extraction operation between the first liquid L1 and the second liquid L2 in this embodiment.

As components for providing the above-described two functions, the phase separator 10 includes a main body container 11, a partition member 12, a mixed-liquid introduction part 14, a first lead-out part 15, a second lead-out part 16, and a circulation-promoting-fluid introduction part 18.

The body container 11 defines a storage space for storing the mixed liquid. The main body container 11 according to this embodiment has a peripheral wall 11c, a top wall 11a, and a bottom wall 11b. The peripheral wall lie has a cylindrical shape enclosing the storage space. The top wall 11a is joined to the upper end of the peripheral wall 11c so as to close the upper end opening that is enclosed with the peripheral wall 11c. The bottom wall 11b is joined to the lower end of the peripheral wall 11c so as to close the lower end opening that is enclosed with the peripheral wall 11c.

The partition member 12 is disposed inside the main body container 11 so as to partition the storage space into a plurality of spaces arranged horizontally. The plurality of spaces are, in this embodiment, a phase separation space 41 and a mutual contact space 42. The phase separation space 41 is a space for separating the mixed liquid into the first liquid phase and the second liquid phase. The mutual contact space 42 is a space for allowing the first liquid L1 and the second liquid L2 to flow vertically while being in contact with each other.

Specifically, the partition member 12 according to this embodiment has a cylindrical shape having an outer diameter smaller than the inner diameter of the peripheral wall 11c, and is fixed at a position coaxial with the peripheral wall 11c on the inner side of the peripheral wall 11c, thereby partitioning the storage space into the phase separation space 41 and the mutual contact space 42. The partition member 12, thus, encloses the mutual contact space 42 while defining the phase separation space 41 between the outer peripheral surface of the partition member 12 and the inner peripheral surface of the peripheral wall 11c.

The partition member 12 according to this embodiment has an axial (vertical) dimension smaller than that of the peripheral wall 11c and is disposed so as to form an upper space 43 between the upper end 12a of the partition member 12 and a container top surface 11d that is the lower surface of the top wall 11a and so as to form a lower space 44 between the lower end 12b of the partition member 12 and a container bottom surface 11e that is the upper surface of the bottom wall 11b. In short, the partition member 12 is disposed so as to be separated from the top wall 11a and the bottom wall 11b vertically inward.

The structure for supporting the partition member 12 in the above-described position is not limited. The partition member 12, for example, can be held by the peripheral wall 11c through a plurality of radial connection members that radially interconnect the outer peripheral surface of the partition member 12 and the peripheral wall 11c. In this case, respective distances between two of the plurality of radial connection members are set to be enough large to allow good phase separation to be performed regardless of the presence of the plurality of radial connection members in the phase separation space 41. Alternatively, the partition member 12 may be either supported by a plurality of leg portions that vertically interconnect the lower end 12b of the partition member 12 and the bottom wall 11b or suspended from the top wall 11a through a plurality of suspension members that interconnect the upper end 12a of the partition member 12 and the top wall 11a.

The mixed-liquid introduction part 14 is a part that allows the mixed liquid to be introduced into the mutual contact space 42 through the mixed-liquid introduction part 14. Specifically, the mixed-liquid introduction part 14 allows the mixed liquid to be introduced so as to make the mixed liquid flow from an introduction end that is an end selected from the upper end 12a and the lower end 12b of the partition member 12 to a discharge end that is an opposite end to the introduction end out of the upper end 12a and the lower end 12b of the partition member 12 through the mutual contact space 42.

In this embodiment, the lower end 12b of the partition member 12 corresponds to the introduction end, and the upper end 12a corresponds to the discharge end. The mixed-liquid introduction part 14 according to this embodiment is, thus, disposed so as to introduce the mixed liquid into the lower end 12b of the partition member 12 to make the mixed liquid rise in the mutual contact space 42 toward the upper end 12a of the partition member 12. The mixed-liquid introduction part 14 may be constituted by, for example, an introduction pipe that encloses the mixed liquid introducing passage. The introduction pipe is disposed so as to extend from the bottom wall 11b to the lower end 12b through the lower space 44 while penetrating the bottom wall 11b of the main body container 11.

The position to which the mixed liquid is introduced through the mixed-liquid introduction part 14, namely, a mixed-liquid introduction position, also can be freely set under the condition of causing the introduced mixed liquid to rise in the mutual contact space 42. The mixed-liquid introduction position, for example, may be either a position below the lower end surface of the partition member 12 (i.e., a position on the outer side of the mutual contact space 42) or a position above the lower end surface (i.e., a position within the mutual contact space 42).

The first lead-out part 15 is provided at a height position where the first liquid phase separated in the phase separation space 41 is present to allow the liquid forming the first liquid phase to be led out from the main body container 11 through the first lead-out part 15. The “liquid forming the first liquid phase” may be either a liquid constituted by only the first liquid L1 or a liquid in which other substance is slightly mixed with the first liquid L1. In either case, the first liquid L1 forming the first liquid phase can be led out through the first lead-out part 15.

The “height position where the first liquid phase separated in the phase separation space 41 is present” is not limited to the height position within the phase separation space 41. The height position only has to be a height position where the first liquid phase is present, regardless of the deviation of the position from the phase separation space 41. The first lead-out part 15 according to this embodiment is provided between the lower end 12b of the partition member 12 and the container bottom surface 11e which is the upper surface of the bottom wall 11b, thus deviated downward from the phase separation space 41. The first lead-out part 15 is, more preferably, provided at a position to which the container bottom surface 11e is closer than the lower end 12b. This makes it possible to further restrain the second liquid L2 from being mixed into the liquid led out through the first lead-out part 15, for example, as compared with the case where the first lead-out part 15 is disposed at a position close to the lower end 12b.

The specific structure of the first lead-out part 15 only has to allow the first liquid L1 forming the first liquid phase in the main body container 11 to be led out of the main body container 11 through the first lead-out part 15. The first lead-out part 15 can be configured by, for example, a lead-out hole formed so as to pass through the peripheral wall 11c in the thickness direction thereof, or a lead-out tube fixed to the peripheral wall 11c while penetrating the peripheral wall 11c. In this embodiment, a first lead-out pipe 45 is connected to the first lead-out part 15 to allow the first liquid L1 forming the first liquid phase to be transported to an appropriate place through the first lead-out pipe 45.

The second lead-out part 16 is provided at a height position where the second liquid phase separated in the phase separation space 41 is present to allow the liquid forming the second liquid phase to be led out from the main body container 11 through the second lead-out part 16. The “liquid forming the second liquid phase” may be either constituted by only the second liquid L2 or a liquid in which other substances are slightly mixed with the second liquid L2. In either case, the second liquid L2 forming the second liquid phase can be led out through the second lead-out part 16.

The “height position at which the second liquid phase separated in the phase separation space 41 is present” is not limited to a height position within the phase separation space 41. The height position only has to be a height position at which the second liquid phase is present, regardless of the deviation of the position from the phase separation space 41. The second lead-out part 16 according to this embodiment is provided between the upper end 12a of the partition member 12 and the container top surface 11d, which is the lower surface of the top wall 11a, thus deviated upward from the phase separation space 41. The second lead-out part 16 is, more preferably, provided at a position to which the container top surface 11d is closer than the upper end 12a. This makes it possible to further restrain the first liquid L1 from being mixed into the liquid led out through the second lead-out part 16, for example, as compared with the case where the second lead-out part 16 is disposed at a position close to the upper end 12a.

The specific structure of the second lead-out part 16 only has to allow the second liquid L2 forming the second liquid phase in the main body container 11 to be led out of the main body container 11 through the second lead-out part 16. Similarly to the first lead-out part 15, the second lead-out part 16 can be constituted by, for example, a lead-out hole formed so as to pass through the peripheral wall 11c in the thickness direction or a lead-out tube fixed to the peripheral wall 11c while penetrating the peripheral wall 11c. In this embodiment, a second lead-out pipe 46 is connected to the second lead-out part 16 to allow the second liquid L2 forming the second liquid phase to be transported to an appropriate place through the second lead-out pipe 46.

Respective spaces formed on the upper side and the lower side of the partition member 12 out of the storage space, namely, the upper space 43 and the lower space 44, allow the circulation of the liquid between the mutual contact space 42 and the phase separation space 41. Specifically, the upper space 43 forms a discharge-side circulation flow path that allows the mixed liquid discharged from the upper end 12a, which is the discharge end of the partition member 12, to transfer to the phase separation space 41, that is, to move radially outward. Similarly, the lower space 44 forms an introduction-side circulation flow path that allows a liquid forming the liquid phase present at a height position of the lower end 12b, which is the introduction end, out of the first liquid phase and the second liquid phase separated in the phase separation space, namely, the first liquid L1 that forms the first liquid phase in this embodiment, to be introduced into the mutual contact space 42 through the introduction end, that, is, to move radially inward.

The circulation-promoting-fluid introduction part 18 is a part that allows the circulation promoting fluid to be introduced into the mutual contact space 42 in the same direction as the mixed liquid (upward in this embodiment) through the circulation-pronating-fluid introduction part 18. In this embodiment, as specifically described below, the second liquid L2 led out from the second lead-out part 16 is introduced into the mutual contact space 42 through the circulation-promoting-fluid introduction part 18 to be used as the circulation promoting fluid.

The circulation promoting fluid is a fluid having a density that promotes the circulation of liquid between the phase separation space 41 and the mutual contact space 42. Specifically, the density of the circulation promoting fluid is such a density that the supply of the circulation promoting fluid into the mutual contact space 42 increases the difference between the density ρs of the fluid in the mutual contact space 42 (hereinafter referred to as “density in mutual contact space”) and the density ρ1 of the liquid that is introduced from the phase separation space 41 into the mutual contact space 42 (in this embodiment, the density ρ1 of the first liquid L1) out of the first liquid and the second liquid.

The density ρ2 of the second liquid L2 utilized as the circulation promoting fluid in this embodiment is smaller than the density ρm of the mixed liquid containing both the first liquid L1 and the second liquid L2, and the density ρm of the mixed liquid is smaller than the density ρ1 of the first liquid L1 (ρ2<ρm<ρ1). The re-introduction of the second liquid L2 into the mutual contact space 42, therefore, makes the density ρs in the mutual contact space smaller than the density ρm of the mixed liquid, thereby increasing the difference Δρ between the density ρ1 of the first liquid L1 and the density ρs in the mutual contact space (Δρ=ρ1−ρs). The second liquid L2, thus, can serve as the circulation promoting fluid in this first embodiment.

The circulation-promoting-fluid introduction part 18 according to this embodiment is disposed so as to introduce the second liquid L2, which is the circulation promoting fluid, into the lower end 12b of the partition member 12 to allow the second liquid L2 as the circulation promoting fluid to rise toward the upper end 12a of the partition member 12 in the mutual contact space 42 together with the mixed liquid, similarly to the mixed-liquid introduction part 14. The circulation-promoting-fluid introduction part 18, therefore, can be constituted by, for example, an introduction pipe enclosing the circulation promoting fluid introduction path, similarly to the mixed-liquid introduction part 14. The introduction pipe is disposed so as to extend from the bottom wall 11b to the lower end 12b through the lower space 44 while penetrating the bottom wall 11b of the main body container 11.

The circulation promoting fluid introduction position, which is the position to which the circulation promoting fluid (the second liquid L2 in this embodiment is introduced through the circulation-promoting-fluid introduction part 18, also can be freely set under the condition of allowing the introduced circulation promoting fluid to flow in the same direction as the mixed liquid in the mutual contact space 42 (rise in this embodiment) together with the mixed liquid. The circulation-promoting-fluid introduction position, thus, may be, for example, either a position below the lower end surface of the partition member 12 (i.e., a position outside the mutual contact space 42) or a position above the lower end surface (i.e., a position within the mutual contact space 42), similarly to the mixed liquid introduction position.

The mixed-liquid supply device 20 is configured to supply the mixed liquid through the mixed-liquid introduction part 14 to the mutual contact space 42. The mixed-liquid supply device 20 according to this embodiment includes an extractor 22 and a mixed-liquid supply pipe 24.

To the extractor 22 are supplied the first liquid L1 and the second liquid L2. The extractor 22 forms an extraction flow path that allow the supplied first and second liquids L1 and L2 to flow while being in contact with each other, enabling an extraction target component contained in the liquid of one of the first liquid and the second liquid to be extracted into the other liquid in the extraction flow path. The extraction flow path may be constituted by, for example, a plurality of micro-channels formed in the extractor 22. The first liquid and the second liquid thus mixed with each other in the extraction flow path are discharged from the extractor 22 as the mixed liquid.

The mixed-liquid supply pipe 24 interconnects the extractor 22 and the mixed-liquid introduction part 14 to lead the mixed liquid discharged from the extractor 22 to the mixed-liquid introduction part 14. The mixed-liquid supply pipe 24 is optional. For example, it is also possible to directly interconnect the extractor 22 and the mixed-liquid introduction part 14 with no pipe. In short, the extractor 22 and the phase separator 10 also can be integrally configured as a composite device. Alternatively, the mixed-liquid introduction part 14 may be extended to the outside of the main body container 11 to function as the mixed-liquid supply pipe.

The second-liquid return device 30 is configured to return the second liquid L2 led out from the second lead-out part 16 to the circulation-promoting-fluid introduction part 18 as the circulation promoting fluid, that is, configured to supply the second liquid L2 into the mutual contact space 42 through the introduction part 18, thus serving as a circulation-promoting-fluid supply device according to the present invention.

The second-liquid return device 30 includes a second-liquid return pipe 32 and a second-liquid return pump 34. The second-liquid return pipe 32 is branched off from the second lead-out pipe 46 and extends to the circulation-promoting-fluid introduction part 18. The second-liquid return pump 34 is provided in the middle of the second-liquid return pipe 32. The second-liquid return pump 34 is driven by a not-graphically-shown drive source to thereby pressure-feed a part of the fluid flowing through the second lead-out pipe 46, namely, the second liquid L2 forming the second liquid phase, to the mutual contact space 42 through the second-liquid return pipe 32 and the circulation-promoting-fluid introduction part 18.

Next will be described the action of the phase separation system.

The first liquid L1 and the second liquid L2 supplied to the extractor 22 flow through the flow path in the extractor 22 while being in contact with each other, thereby allowing a specific extraction target component from one of the first liquid L1 and the second liquid L2 to the other. From the extractor 22 is discharged a mixed liquid containing the first liquid L1 and the second liquid L2, then introduced into a predetermined mixed-liquid introduction position, preferably, a position in the vicinity of the lower end 12b, which is the introduction end of the partition member 12, through the mixed-liquid supply pipe 24 and the mixed-liquid introduction part 14.

The mixed liquid thus introduced rises in the mutual contact space 42 enclosed with the partition member 12, during which an extraction operation following the extraction operation in the extractor 22 is caused by the mutual contact between the first liquid L1 and the second liquid L2. The mixed liquid having reached the upper end 12a of the partition member 12 passes through the upper space 43 radially outward to reach the upper end of the phase separation space 41, in which the first liquid L1 (heavy liquid) having a relatively large specific gravity and the second liquid L2 (light liquid) having a relatively small specific gravity are separated vertically from each other. Specifically, a second liquid phase constituted by the second liquid L2 is formed above the first liquid phase constituted by the first liquid L1, between which liquid phases an interface SL is located in the phase separation space 41.

The first liquid L1 and the second liquid L2 forming the first liquid phase and the second liquid phase, respectively, are led out to the outside of the main body container 11 through the first lead-out part 15 and the second lead-out part 16, respectively. Besides, the liquid that forms the liquid phase located at the same height as the lower end 12b of the partition member 12, which is the introduction end, out of the first and second liquid phases, namely, the first liquid L1 forming the first liquid phase located on the lower side in this embodiment, passes through the lower space 44 radially inward to reach the lower end of the mutual contact space 42, being merged with the mixed liquid which is newly introduced through the mixed-liquid introduction part 14.

On the other hand, a part of the second liquid L2 led out through the second lead-out part 16 is returned to the circulation-promoting-fluid introduction part 18 through the second-liquid return pipe 32, and supplied into the mutual contact space 42 together with the mixed liquid. The density ρ2 of the second liquid L2 is smaller than the density ρm of the mixed liquid (ρm>ρ2), which allows the re-introduction of the second liquid L2 to reduce the density of the fluid flowing in the mutual contact space 42, namely, the density ρs in the mutual contact space. This increases the density difference Δρ (=ρ1−ρs) between the density ρ1 (>ρm) of the first liquid L1 to be transferred from the phase separation space 41 to the mutual contact space 42 and the density ρs in the mutual contact space, thereby promoting the circulation of the liquid between the phase separation space 41 and the mutual contact space 42. Specifically, the circulation flow of the liquid related to the circulation involves a transfer of the mixed liquid discharged from the upper end 12a, which is the discharge end of the partition member 12, into the phase separation space 41, and a transfer of the first liquid L1 forming the first liquid phase out of the first liquid phase and the second liquid phase separated in the phase separation space 41 into the mutual contact space 42, and the increase in the density difference Δρ promotes both the transfers to thereby promote the formation of circulation flow.

Such circulation of liquid in the storage space enables both the phase separation in the phase separation space 41 and the extraction caused by the mutual contact between the first liquid L1 and the second liquid L2 in the mutual contact space 42 to be efficiently advanced at the same time, that is, enables the extraction operation to be complemented downstream of the extractor 22 while performing the phase separation of the mixed liquid in the phase separator 10. This allows the lack of extraction due to some accident in the extractor 22, which is an upstream device, to be compensated in the phase separator 10. The accident is, for example, a large variation in the ratio of the extraction target component in the first liquid L1 or the second liquid L2, or a flow defect caused by a clogging or the like of the flow path in the extractor 22. The complementation of the extraction operation in the phase separator 10, alternatively, allows the extractor 22 to be downsized in view of possible extraction in the phase separator 10.

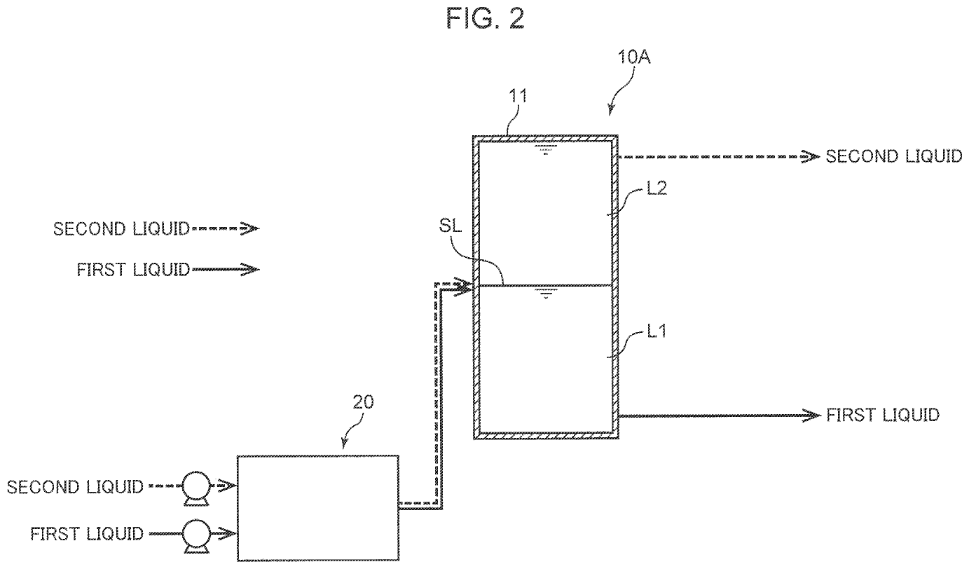

Furthermore, the phase separator 10 allows the phase separation and the mutual contact to be simultaneously achieved in a compact structure. This can be further clarified by comparison with a phase separator 10A according to the comparative example as shown in FIG. 2. The phase separator 10A according to the comparative example has a main body container 11 similarly to the phase separator 10 according to the embodiment, the main body container 11 defining an storage space for receiving a mixed liquid supplied from a mixed-liquid supply device 20, but the phase separator 10A has no partition member for partitioning the storage space into a phase separation space and a mutual contact space. In short, according to the phase separator 10A, similarly to a conventional phase separator (so-called settler), the entire storage space in the main body container 11 is used as a phase separation space.

Although the phase separator 10A according to the comparative examples also allows the first liquid L1 and the second liquid L2 to be in contact with each other at the interface SL between the first liquid phase formed of the first liquid L1 and the second liquid phase formed of the second liquid L2, what the interface SL allows to be in mutual contact is only respective small parts of the first liquid L1 and the second liquid L2, and such contact cannot allow sufficient extraction or the like to be expected. In other words, providing sufficient mutual contact between the first liquid L1 and the second liquid L2 in the phase separator 10A according to the comparative examples requires the interface SL to have an enormous area, which inevitably involves a remarkable increase in size of the phase separator 10A, in particular, a remarkable increase in the installation area seen from above, namely, an increase in the horizontal size.

On the other hand, in the phase separator 10, the partition of the storage space in the main body container 11 into the phase separation space 41 and the mutual contact space 42, which are horizontally arranged, by the partition member 12 enables the phase separation of the mixed liquid and the mutual contact between the first liquid L1 and the second liquid L2 to be simultaneously achieved in a compact structure. In particular, the partition member 12, having a cylindrical shape with an outer diameter smaller than the inner diameter of the main body container 11 and enclosing the mutual contact space 42 while defining the phase separation space 41 between the outer circumferential surface of the partition member 12 and the inner circumferential surface of the main body container 11, allows liquid to transfer between the spaces 41 and 42 radially and uniformly over the entire circumference of the partition member 12.

Besides, the re-introduction of the second liquid L2 as a circulation promoting fluid into the mutual contact space 42 promotes the circulation of liquid between the mutual contact space 42 and the phase separation space 41, thereby rendering the effect of simultaneously achieving the phase separation and the mutual contact more reliable. In particular, in this first embodiment, utilizing the second liquid L2 that has been led out from the phase separator 10 through the second lead-out part 16 as the circulation promoting fluid allows the promotion of the circulation to be efficiently performed. In addition, the utilization can also restrain the balance between the first liquid L1 and the second liquid L2 in the mutual contact space 42 from being varied by the transfer of the first liquid L1 that forms the first liquid phase formed in the phase separation space 41 to the mutual contact space 42.

The introduction of the circulation promoting fluid is, however, not limited to a mode with utilization of the second liquid L2 having been led out. For example, the circulation promoting fluid may be a newly supplied second liquid L2 or may be a liquid having a smaller density than the density ρ2 of the second liquid L2.

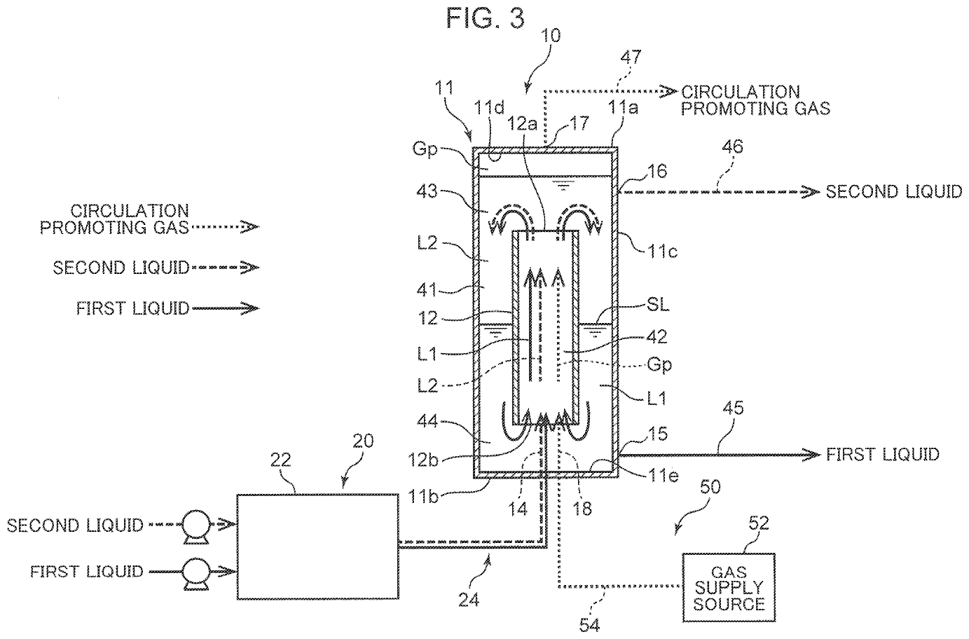

FIG. 3 shows a phase separation system according to the second embodiment. This phase separation system uses a circulation promoting gas as the circulation promoting fluid. The circulation promoting gas, having a further smaller density ρg (<ρ2) than the density ρ2 of the second liquid L2, can more effectively promote the circulation of liquid in the storage space than the first embodiment.

Specifically, the phase separation system according to the second embodiment includes a gas supply device 50, as the circulation-promoting-fluid supply device, in place of the second-liquid return device 30 according to the first embodiment, as shown in FIG. 3. The gas supply device 50 supplies a circulation promoting gas Gp as the circulation promoting fluid to the circulation-promoting-fluid introduction part 18 of the phase separator 10. FIG. 3 shows a thin broken line arrow that indicates the flow of the circulation promoting gas Gp.

The gas supply device 50 includes a gas supply source 52 and a gas supply pipe 54. The gas supply pipe 54 interconnects the gas supply source 52 and the circulation-promoting-fluid introduction part 18. The gas supply source 52 supplies the circulation promoting gas Gp to the circulation-promoting-fluid introduction part 18 through the gas supply pipe 54.

The gas supply source 52, preferably, supplies the circulation promoting gas Gp with a pressure equal to or higher than a predetermined pressure, that is, pressure-feeds, to the circulation-promoting-fluid introduction part 18. This makes it possible to promote the upward flow of fluid in the mutual contact space 42. The pressure-feeding may be performed either by use of a fluid machine such as a pump or by utilization of an internal pressure of a container that stores the circulation promoting gas Gp, for example, a gas cylinder.

Preferably, the circulation promoting gas Gp is insoluble in each of the first liquid L1 and the second liquid L2. The circulation promoting gas Gp, however, may be soluble in the first liquid L1 or the second liquid L2 to such a limited degree that the circulation promoting gas Gp can keep its function as a circulation promoting fluid and has no effect on properties required for either the first liquid L1 or the second liquid L2. As the circulation promoting gas Gp, for example, nitrogen or air is suitable. Both nitrogen and air have the advantages of (1) low activity on various liquids, (2) high safety, and (3) high availability.

The phase separator 10 shown in FIG. 3 further includes a gas lead-out part 17. The gas lead-out part 17 allows the circulation promoting gas Gp having risen in the mutual contact space 42 to be led out of the phase separator through the gas lead-out part 17, thereby preventing the circulation promoting gas Gp from accumulating in the phase separator 10.

The circulation promoting gas Gp rises over the second liquid L2 to accumulate in the top part of the main body container, which requires the gas lead-out part 17 to be located above the second lead-out part 16, more specifically, above the second liquid phase. The gas lead-out part 17 is, preferably, provided in the top of the main body container 11 as shown in FIG. 3. In this case, the gas lead-out part 17 can be constituted by, for example, a lead-out hole formed in the top wall 11a so as to pass through the top wall 11a of the main body container 11 in the thickness direction, or a lead-out pipe that penetrates the top wall 11a to be fixed thereto while enclosing the gas lead-out path. In the mode shown in FIG. 3, a gas lead-out pipe 47 is connected to the gas lead-out part 17 to allow the circulation promoting gas Gp to be lead out to proper places through the gas lead-out pipe 47.

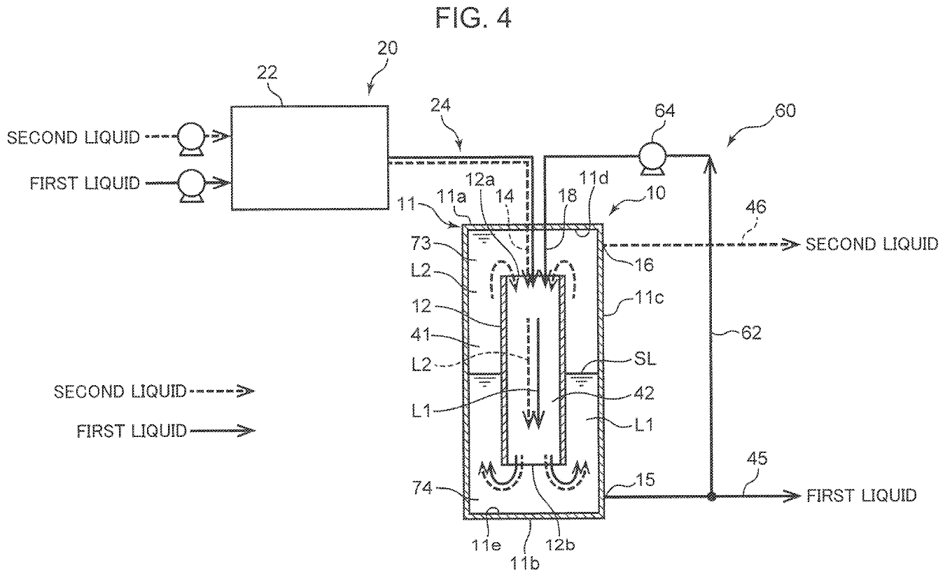

FIG. 4 shows a phase separation system according to a third embodiment of the present invention. Although, in the phase separator 10 according to the first and second embodiments, the lower end 12b is selected as the introduction end and the upper end 12a is selected as the discharge end, out of the upper end 12a and the lower end 12b of the partition member 12, in the phase separator 10 of the phase separation system shown in FIG. 4, the upper end 12a of the partition member 12 corresponds to the introduction end and the lower end 12b corresponds to the discharge end. Accordingly, the mixed liquid supplied from the mixed-liquid supply device 20 is supplied from above to the mutual contact space 42 enclosed with the partition member 12 and introduced so as to fall down in the mutual contact space 42. The circulating flow formed in this embodiment involves the radially outward transfer of the mixed liquid having been discharged downward from the lower end 12b, which is the discharge end of the partition member 12, to the phase separation space 41 through a lower space 74 that forms the discharge side circulating flow path, and the radially inward transfer of the second liquid L2 forming the second liquid phase which is the liquid phase at the same height position as the upper end 12a which is the introduction end of the partition member 12 out of the first liquid phase and the second liquid phase formed in the phase separation space 41 to the mutual contact space 42 through an upper space 73 that forms the introduction side circulating flow path.

Specifically, the phase separator 10 according to this embodiment also includes the mixed-liquid introduction part 14 in the same manner as the phase separator 10 according to the first embodiment, but the mixed-liquid introduction part 14 is disposed so as to introduce the mixed liquid at a height position in the vicinity of the upper end 12a of the partition member 12, namely, a mixed-liquid introduction, to make the mixed liquid fall down in the mutual contact space 42 toward the lower end 12b. The mixed-liquid introduction part 14 can be constituted by, for example, an introduction pipe that penetrates the top wall 11a of the main body container 11 and extends from the top wall 11a to the mixed-liquid introduction position through the upper space 73.

The phase separator 10 according to this embodiment also includes a circulation-promoting-fluid introduction part 18 for introducing the circulation promoting fluid, but the circulation to be promoted involves the downward flow of mixed liquid in the mutual contact space 42, requiring the circulation promoting fluid for promoting the circulation to have a density to increase the density ρs in the mutual contact space, which is the density of the fluid flowing in the mutual contact space 42.

Specifically, in this embodiment, the first liquid L1 led out from the first lead-out part 15 is used as the circulation promoting fluid. The density ρ1 of the first liquid L1 is larger than the density ρm of the mixed liquid containing both the first liquid L1 and the second liquid L2 and the density ρm of the mixed liquid is larger than the density ρ2 of the second liquid L2 (ρ1>ρm>ρ2), which allows the re-introduction of the first liquid L1 into the mutual contact space 42 to make the density ρs in the mutual contact space larger than the density μm of the mixed liquid, thereby increasing the difference Δρbetween the density ρs in the mutual contact space and the density ρ2 of the second liquid L2 (Δρ=ρs−ρ2). This makes it possible to promote the above circulation involving the fall of the fluid in the mutual contact space 42.

The circulation-promoting-fluid introduction part 18 according to this embodiment is also disposed so as to introduce the first liquid L1 as the circulation promoting fluid into the upper end 12a of the partition member 12 to make the first liquid L1 as the circulation promoting fluid flow in the same direction as the mixed liquid, that is, fall down in the mutual contact space 42 toward the lower end 12b of the partition member 12, similarly to the mixed-liquid introduction part 14. The circulation-promoting-fluid introduction part 18, therefore, can be constituted by, for example, an introduction pipe enclosing the circulation-promoting-fluid introduction flow path. The introduction pipe is disposed so as to extend from the top wall 11a to the upper end 12a through the upper space 73 while penetrating the top wall 11a.

In this embodiment, the position to which the first liquid L1 as the circulation promoting fluid is introduced, namely, the circulation-promoting-fluid introduction position, also can be freely set under the condition of allowing the introduced circulation promoting fluid to fall down in the mutual contact space 42 together with the mixed liquid. Hence, the circulation-promoting-fluid introduction position may be, for example, either a position above the upper end surface of the partition member 12 (i.e., a position outside the mutual contact space 42) or a position below the upper end surface (i.e., a position within the mutual contact space 42), similarly to the mixed-liquid introduction position.

The phase separation system according to this embodiment includes a first-liquid return device 60, as the circulation-promoting-fluid supply device, in place of the second-liquid return device 30 according to the first embodiment. The first-liquid return device 60 returns the first liquid L1 led out from the first lead-out part 15 to the circulation-promoting-fluid introduction part 18 as the circulation promoting fluid.

The first-liquid return device 60 includes a first liquid return pipe 62 and a first liquid return pump 64. The first liquid return pipe 62 is branched off from the first lead-out pipe 45 and extends to the circulation-promoting-fluid introduction part 18. The first liquid return pump 64 is provided in the middle of the first liquid return pipe 62 and driven by a not-graphically-shown drive source to thereby pressure-feed a part of the fluid flowing through the first lead-out pipe 45, namely, the first liquid L1 forming the first liquid phase, through the first liquid return pipe 62 and the circulation-promoting-fluid introduction part 18 to the mutual contact space 42.

In this phase separation system, the mixed liquid supplied from the mixed-liquid supply device 20 to the mixed-liquid introduction part 14 falls down in the mutual contact space 42 enclosed with the partition member 12 in contrast to the first embodiment, during which the extraction operation following the extraction operation in the extractor 22 of the mixed-liquid supply device 20 is performed by the mutual contact between the first liquid L1 and the second liquid L2. The mixed liquid having reached the lower end 12b of the partition member 12 passes through the lower space 74 radially outward to reach the lower end of the phase separation space 41, and phase separation is performed in the phase separation space 41 similarly to the first embodiment. Also in the third embodiment, thus, a second liquid phase constituted by the second liquid L2 is formed above the first liquid phase constituted by the first liquid L1, between which liquid phases an interface SL is located in the phase separation space 41. Besides, the first liquid L1 and the second liquid L2 forming the first liquid phase and the second liquid phase, respectively, are led out to the outside of the main body container 11 through the first lead-out part 15 and the second lead-out part 16, respectively.

In this third embodiment, the liquid that forms the liquid phase located at the same height as the upper end 12a of the partition member 12 which is the introduction end out of the first and second liquid phases is the second liquid L2 forming the second liquid phase. The second liquid L2, therefore, passes through the upper space 73 radially inward to reach the upper end of the mutual contact space 42, being merged with the mixed liquid that is newly introduced through the mixed-liquid introduction part 14.

On the other hand, a part of the first liquid L1 led out through the first lead-out part 15 is returned to the circulation-promoting-fluid introduction part 18 through the first liquid return pipe 62, and supplied as a circulation promoting fluid into the mutual contact space 42 together with the mixed liquid. The density ρ1 of the first liquid L1 is larger than the density μm of the mixed liquid (ρ1>ρm), which allows the re-introduction of the first liquid L1 to increase the density of the fluid flowing in the mutual contact space 42, that is, the density ρs in the mutual contact space. This increases the density difference Δρ (=ρs−ρ2), which is the difference between the density ρs in the mutual contact space and the density ρ2 (<ρm) of the second liquid L2 to be transferred from the phase separation space 41 to the mutual contact space 42, promoting the circulation of liquid between the phase separation space 41 and the mutual contact space 42. Such circulation enables both the phase separation of the mixed liquid and the mutual contact between the first liquid L1 and the second liquid L2 to be efficiently performed at the same time in a compact structure, similarly to the first and second embodiments.

The third embodiment or the like where the upper end 12a of the partition member 12 is the introduction end and the mixed liquid falls down from the upper end 12a toward the end 12b in the mutual contact space 42 permits also a liquid having a density larger than the density ρ1 of the first liquid L1 to be used as the circulation promoting fluid. The use enables the density difference Δρ, which is the difference between the density ρs of the fluid in the mutual contact space 42, the fluid containing the liquid, and the density ρ2 of the second liquid L2, to be larger, thereby enabling the circulation to be more effectively promoted.

The present invention is not limited to the above-described embodiments. It is possible for the present invention to encompass aspects such as, for example, the following.

(A) Shape and Arrangement of Main Body Container and Partition Member

The specific shape and arrangement of the main body container and the partition member according to the present invention, and the shape and arrangement of each space formed by them are not limited.

The main body container may be, for example, a rectangular parallelepiped or spherical container. For example, it is also possible to make the outer periphery of the part located at the same height as the interface between the first and second liquid phase in the main body container larger than the outer periphery of the other part, or to make the outer periphery of the part located at the same height as the interface in the partition member smaller than the outer periphery of the other part, each of which enable the interface to have a large area with no change in the volume of the entire body container.

The upper and lower ends of the partition member do not absolutely have to be separated from each of the top wall and the bottom wall of the main body container. For example, the upper end of the partition member may be joined to the top wall of the main body container or the lower end of the partition member may be joined to the bottom wall of the main body container. In the former case, forming a through hole or a notch in the upper end of the partition member allows an upper-side circulation flow path (a discharge-side circulation flow path in the first and second embodiments and an introduction-side circulation flow path in the third embodiment) to be secured. Similarly, in the latter case, forming a through hole or a notch in the lower end of the partition member allows a lower circulation flow path (an introduction-side circulation flow path in the first and second embodiments and a discharge-side circulation flow path in the third embodiment) to be formed.

The partition member is not limited to one that partitions the storage space into a radially inner space and a radially outer space as in the first to third embodiments. The partition member may partition the storage space into right and left portions. Also in this case, one of the partitioned spaces can be used as a phase separation space and the other as a mutual contact space.

The partition member, furthermore, may be one that partitions the storage space into three or more spaces. The three or more spaces only has to include at least one phase separation space and at least one mutual contact space, thus being also permitted to include a space for purpose other than the phase separation or the mutual contact. The partition member, besides, may be one that defines a plurality of phase separation spaces or a plurality of mutual contact spaces. For example, may be used a plurality of tubular partition members each extending vertically. The plurality of tubular partition members, for example, can be horizontally spaced in the storage space, each enclosing an independent mutual contact space while defining a space outside the plurality of partition members as a phase separation space.

Furthermore, in order to promote mutual contact between the first liquid and the second liquid in the mutual contact space, may be provided a baffle plate or the like for forming a meandering flow path in the mutual contact space.

(B) Lead-Out Positions of First and Second Liquids

Respective positions at which the first liquid and the second liquid are led out, that is, respective positions of the first and second lead-out parts, can be appropriately set. It is preferable that the position at which the first liquid is led out is a position at which the second liquid is restrained from being mixed into the first liquid, and, similarly, it is preferable that the position at which the second liquid is led out is a position at which the first liquid is restrained from being mixed into the second liquid. Specifically, the position of the first lead-out part is preferably a position as spaced as possible downward or radially outward from the lower end of the partition member; similarly, the position of the second lead-out part is preferably a position as spaced as possible upward or radially outward from the upper end of the partition member. In addition, may be provided a baffle plate or the like to prevent the mixing in the vicinity of the first lead-out part or the second lead-out part.

(C) Circulation Promoting Fluid

In the present invention, introducing a circulation promoting fluid into the phase separator is optional. In the case of no need for promoting the circulation, for example, the case where the difference between the specific gravity of the first liquid and the specific gravity of the second liquid is remarkably large, or the case where the introduction pressure or the introduction flow rate of the mixed liquid into the mutual contact space is large, the introduction of the circulation promoting fluid is omittable.

As described above, there are provided a phase separator having both a function of bringing a mixed liquid containing a first liquid and a second liquid into phase separation and a function of promoting mutual contact between the first liquid and the second liquid in a compact structure, a phase separation system including the same, and a phase separation method using the phase separator.

Provided is a phase separator that receives a mixed liquid to bring the mixed liquid into phase separation, the mixed liquid containing a first liquid and a second liquid that are capable of forming a first liquid phase and a second liquid phase, respectively, the first liquid being immiscible with the second liquid and having a larger specific gravity than a specific gravity of the second liquid. The phase separator includes a main body container, a partition member, a mixed-liquid introduction part, a first lead-out part, and a second lead-out part. The body container defines a storage space for storing the mixed liquid. The partition member is disposed inside the main body container so as to partition the storage space into a plurality of spaces arranged horizontally. The plurality of spaces include a mutual contact space allowing the first liquid and the second liquid to flow vertically while being in contact with each other in the mutual contact space, and a phase separation space for separating the mixed liquid into the first liquid phase formed of the first liquid and the second liquid phase formed of the second liquid. The mixed-liquid introduction part allows the mixed liquid to be introduced into the mutual contact space through the mixed-liquid introduction part so as to make the mixed liquid flow from an introduction end that is an end selected from an upper end and a lower end of the partition member to a discharge end that is an end opposite to the introduction end selected from the upper end and the lower end of the partition member. The first lead-out part is provided at a height position where the first liquid phase separated in the phase separation space is present to allow the first liquid forming the first liquid phase to be led out from the main body container through the first lead-out part. The second lead-out part is provided at a height position where the second liquid phase separated in the phase separation space is present to allow the second liquid forming the second liquid phase to be led out from the main body container through the second lead-out part. The storage space is formed with a discharge-side circulation flow path that allows the mixed liquid discharged from the discharge end of the partition member to transfer to the phase separation space, and an introduction-side circulation flow path that allows a liquid forming a liquid phase that is present at the height position of the introduction end out of the first liquid phase and the second liquid phase that are separated in the phase separation space to be introduced into the mutual contact space through the introduction end.

This phase separator, allowing an appropriate circulation of liquid to be formed between the mutual contact space and the phase separation space in the storage space, enables both of phase separation of the mixed liquid into the first liquid phase and the second liquid phase and promotion of the reaction through the mutual contact between the first liquid and the second liquid to be simultaneously achieved. Specifically, the mixed liquid introduced into the mutual contact space through the mixed-liquid introduction part flows in the mutual contact space from the introduction end toward the discharge end of the partition member, during which mutual contact between the first liquid and the second liquid contained in the mixed liquid is promoted. The mixed liquid having flowed in the mutual contact space can be introduced into the phase separation space from the discharge end through the discharge-side circulation flow path, and, in this phase separation space, the mixed liquid is separated into a first liquid phase and a second liquid phase by the difference between respective specific gravities of the first liquid and the second liquid. The liquid forming the liquid phase that is one of the thus separated first and second liquid phases and that is a phase present at the same height position as the introduction end is introduced into the mutual contact space from the introduction end through the introduction-side circulation flow path. The liquid is thus circulated between the mutual contact space and the phase separation space, which circulation enables the phase separation of the mixed liquid and the operation (e.g., extraction operation) cause by the mutual contact between the first liquid and the second liquid to be efficiently advanced at the same time.

It is preferable that the partition member has a cylindrical shape extending vertically and enclosing the mutual contact space, defining the phase separation space between an outer peripheral surface of the partition member and the main body container. Such arrangement of the mutual contact space and the phase separation space enables the circulation of liquid between the two spaces to be carried out efficiently and uniformly over the entire circumference of the cylindrical partition member.

It is preferable that the lower end of the partition member is located above a container bottom surface that is a bottom surface of the main body container and that the first lead-out part is located at a height position between the lower end of the partition member and the container bottom surface, the height position being a position to which the container bottom surface is closer than the lower end. This effectively restrains the second liquid from being mixed into the liquid led out through the first lead-out part.

Similarly, it is preferable that the upper end of the partition member is located at a position below a container top surface that is a top surface of the main body container and that the second lead-out part is located at a height position between the upper end of the partition member and the container top surface, the height position being a position to which the container top surface is closer than the upper end. This effectively restrains the first liquid from being mixed into the liquid led out through the second lead-out part.

The phase separator, preferably, further includes a circulation-promoting-fluid introduction part. The circulation-promoting-fluid introduction part allows the circulation promoting fluid to be introduced into the mutual contact space through the circulation-promoting-fluid introduction part in the same direction as the mixed liquid. The circulation promoting fluid is a fluid having such a density that supply of the circulation promoting fluid into the mutual contact space increases a difference between a density of the fluid in the mutual contact space and a density of the liquid introduced into the mutual contact space from the phase separation space out of the first liquid and the second liquid to thereby promote circulation of the liquid between the phase separation space and the mutual contact space.

Besides, according to the present invention, there is provided a phase separation system including the phase separator and a mixed-liquid supply device that supplies the mixed liquid to the mutual contact space in the phase separator through the mixed-liquid introduction part.

It is preferable that the mixed-liquid supply device includes, for example, an extractor which brings the first liquid and the second liquid into contact with each other to allow an extraction target component contained in one of the first liquid and the second liquid to be extracted into the other liquid of the first liquid and the second liquid, the extractor being connected to the mixed-liquid introduction part so as to allow the mixed liquid discharged from the extractor and containing the first liquid and the second liquid to be supplied to the mutual contact space through the mixed-liquid introduction part. This phase separation system enables the extraction in the extractor to be complemented by the mutual contact between the first liquid and the second liquid in the mutual contact space in the phase separator. This makes it possible to achieve at least one of conducting a more reliable extraction operation and downsizing the extractor.

When including the phase separator with the circulation-promoting-fluid introduction part, the phase separation system, preferably, further includes a circulation-promoting-fluid supply device that supplies the circulation promoting fluid into the mutual contact space through the circulation-promoting-fluid introduction part.

In the case where the introduction end of the partition member is the lower end of the partition member, that is, the case where the mixed liquid flows upward in the mutual contact space to transfer from the upper end of the partition member to the phase separation space and the liquid forming the first liquid phase transfers to the mutual contact space, the circulation-promoting-fluid supply device, preferably, is configured to supply the second liquid or a fluid having a density smaller than the density of the second liquid to the circulation-promoting-fluid introduction part as the circulation promoting fluid. This makes it possible to reliably render the difference between the density of the first liquid which is a liquid introduced into the mutual contact space from the phase separation space and the density of the fluid which rises in the mutual contact space while containing the circulation promoting fluid (<the density of the first liquid) remarkable to thereby promote the circulation.

More specifically, it is preferable that the circulation-promoting-fluid supply device includes a second-liquid return device that returns the second liquid led out from the phase separator through the second lead-out part to the circulation-promoting-fluid introduction part of the phase separator as the circulation promoting fluid. The second-liquid return device enables the second liquid discharged from the phase separator to be effectively utilized to facilitate the circulation in the phase separator. Besides, the return of the second liquid can also restrain the balance between the first liquid and the second liquid in the mutual contact space from being varied by the transfer of the first liquid from the phase separation space to the mutual contact space.

The circulation-promoting-fluid supply device, alternatively, may be configured to supply a circulation promoting gas as the circulation promoting fluid to the circulation-promoting-fluid introduction part. Thus using not a liquid but a gas as the circulation promoting fluid makes it possible to render the difference between the density of the fluid in the mutual contact space (including the gas) and the density of the first liquid introduced from the phase separation space into the mutual contact space significant to thereby promote the circulation more effectively.

In this case, it is preferable that the phase separator further includes a gas lead-out part located above the second lead-out to allow the circulation promoting gas having risen in the mutual contact space to be led out to the outside of the phase separator through the gas lead-out part. This prevents the circulation promoting gas from accumulating in the phase separator.

Specifically, it is more preferable that the gas lead-out part is provided in a top part of the main body container, because the circulation promoting gas rises to a position above the second liquid to accumulate in the top part of the main body container.

On the other hand, in the case where the introduction end of the partition member is the upper end of the partition member, that is, the case where the mixed liquid flows downward in the mutual contact space to transfer from the lower end of the partition member to the phase separation space and the liquid forming the second liquid phase in the phase separation space transfers to the mutual contact space, it is preferable that the circulation-promoting-fluid supply device is configured to supply the first liquid or a liquid having a density larger than the density of the first liquid as the circulation promoting fluid to the circulation-promoting-fluid introduction part. This makes it possible to reliably render the difference between the density of the second liquid, which is the liquid introduced from the phase separation space into the mutual contact space, and the density of the fluid falling down in the mutual contact space while containing the circulation promoting fluid (>the density of the second liquid) remarkable to thereby promote the circulation.

More specifically, the circulation-promoting-fluid supply device, preferably, includes a first-liquid return device that returns the first liquid led out from the phase separator through the first lead-out part to the circulation-promoting-fluid introduction part of the phase separator as the circulation promoting fluid. The first-liquid return device enables the first liquid discharged from the phase separator to be effectively utilized to promote the circulation in the phase separator. Besides, the return of the first liquid can also restrain the balance between the first liquid and the second liquid in the mutual contact space from being varied by the transfer of the second liquid from the phase separation space to the mutual contact space.

The circulation-promoting-fluid supply device, alternatively, may be configured to supply a circulation promoting liquid having a density larger than the density of the first liquid as the circulation promoting fluid to the circulation-promoting-fluid introduction part.

Also provided is a phase separation method for bringing a mixed liquid containing a first liquid and a second liquid into phase separation, the first liquid and the second liquid being capable of forming a first liquid phase and a second liquid phase, respectively, the first liquid being immiscible with the second liquid and having a specific gravity larger than a specific gravity of the second liquid. The phase separation method includes: providing the phase separator; introducing the mixed liquid into the mutual contact space through the mixed-liquid introduction part to make the mixed liquid flow from the introduction end of the partition member of the phase separator to the discharge end that is an end opposite to the introduction end out of the upper end and the lower end of the partition member through the mutual contact space to thereby form a circulation flow of liquid involving a transfer of the mixed liquid discharged from the discharge end of the partition member to the phase separation space and a transfer of the liquid forming a liquid phase that is present at the height of the introduction end of the partition member out of the first liquid phase and the second liquid phase separated in the phase separation space to the mutual contact space; leading out the first liquid forming the first liquid phase from the main body container through the first lead-out part; and leading out the second liquid forming the second liquid phase from the main body container through the second lead-out part.

It is preferable that a mixed liquid containing the first liquid and the second liquid is supplied to the mixed-liquid introduction part, the supplied mixed liquid being a liquid discharged from, for example, an extractor that brings the first liquid and the second liquid into mutual contact to allow an extraction target component contained in one of the first liquid and the second liquid to be extracted into the other of the first liquid and the second liquid. This method allows the extraction in the extractor to be complemented by the mutual contact between the first liquid and the second liquid in the mutual contact space in the phase separator.

In the case where the phase separator includes the circulation-promoting-fluid introduction part, the phase separation method, preferably, further includes supplying the circulation promoting fluid into the mutual contact space through the circulation promoting fluid to thereby promote circulation of the liquid.

In the case where the introduction end of the partition member is the lower end of the partition member, that is, the case where the mixed liquid flows upward in the mutual contact space and transfers from the upper end of the partition member to the phase separation space and the first liquid forming the first liquid phase in the phase separation space transfers to the mutual contact space, it is preferable that the second liquid or a fluid having a density smaller than the density of the second liquid is supplied as the circulation promoting fluid to the circulation-promoting-fluid introduction part.

More specifically, it is possible either that the second liquid led out from the phase separator through the second lead-out part is returned to the circulation-promoting-fluid introduction part of the phase separator as the circulation promoting fluid or that a circulation promoting gas is supplied to the circulation-promoting-fluid introduction part as the circulation promoting fluid.

On the other hand, in the case where the introduction end of the partition member is the upper end of the partition member, that is, the case where the mixed liquid flows downward in the mutual contact space to transfer from the lower end of the partition member to the phase separation space and the second liquid forming the second liquid phase in the phase separation space transfers to the mutual contact space, it is preferable that the first liquid or a liquid having a density larger than the density of the first liquid is supplied to the circulation-promoting-fluid introduction part as the circulation promoting fluid.

More specifically, it is possible either that the first liquid led out from the phase separator through the first lead-out part is returned to the circulation-promoting-fluid introduction part of the phase separator as the circulation promoting fluid or that a circulation promoting liquid having a density larger than the density of the first liquid is supplied to the circulation-promoting-fluid introduction part as the circulation promoting fluid.

This application is based on Japanese Patent application No. 2020-146837 filed on Sep. 1, 2020 in Japan Patent Office, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A phase separator that receives a mixed liquid to bring the mixed liquid into phase separation, the mixed liquid containing a first liquid and a second liquid that are capable of forming a first liquid phase and a second liquid phase, respectively, the first liquid being immiscible with the second liquid and having a larger specific gravity than a specific gravity of the second liquid, the phase separator comprising:
a main body container that defines a storage space for storing the mixed-liquid;
a partition member disposed inside the main body container so as to partition the storage space into a plurality of spaces arranged horizontally, the plurality of spaces including a mutual contact space allowing the first liquid and the second liquid to flow vertically while being in contact with each other in the mutual contact space, and a phase separation space for separating the mixed liquid into a first liquid phase formed of the first liquid and a second liquid phase formed of the second liquid;
a mixed-liquid introduction part disposed so as to allow the mixed liquid to be introduced into the mutual contact space through the mixed-liquid introduction part to make the mixed liquid flow from an introduction end selected from an upper end and a lower end of the partition member through the mutual contact space toward a discharge end that is an end opposite to the introduction end out of the upper end and the lower end of the partition member;
a first lead-out part provided at a height position where the first liquid phase separated in the phase separation space is present to allow the first liquid forming the first liquid phase to be led out of the main body container through the first lead-out part; and
a second lead-out part provided at a height position where the second liquid phase separated in the phase separating space is present to allow the second liquid forming the second liquid phase to be led out of the main body container through the second lead-out part, wherein
the storage space is formed with a discharge-side circulation flow path that allows the mixed liquid discharged from the discharge end of the partition member to transfer to the phase separation space, and an introduction-side circulation flow path that allows a liquid that forms a liquid phase present at a height position of the introduction end out of the first liquid phase and the second liquid phase separated in the phase separation space to be introduced into the mutual contact space through the introduction end.

2. The phase separator according to claim 1, wherein the partition member has a cylindrical shape extending vertically and enclosing the mutual contact space and defines the phase separation space between an outer peripheral surface of the partition member and the main body container.

3. The phase separator according to claim 1, wherein the lower end of the partition member is located above a container bottom surface, which is a bottom surface of the main body container, and the first lead-out part is located at a height position between the lower end of the partition member and the container bottom surface, the height position being a position to which the container bottom surface is closer than the lower end.

4. The phase separator according to claim 1, wherein the upper end of the partition member is located below a container top surface of the container, which is a top surface of the main body container, and the second lead-out part is located at a height position between the upper end of the partition member and the container top surface, the height position being a position to which the container top surface is closer than the upper end.

5. The phase separator according to claim 1, further comprising a circulation-promoting-fluid introduction part for introducing a circulation promoting fluid having such a density that supply of the circulation promoting fluid into the mutual contact space increases a difference between a density of the fluid in the mutual contact space and a density of the liquid introduced into the mutual contact space from the phase separation space out of the first liquid and the second liquid to thereby promote circulation of the liquid between the phase separation space and the mutual contact space, the circulation-promoting-fluid introduction part being disposed so as to allow the circulation promoting fluid to be introduced into the mutual contact space through the circulation-promoting-fluid introduction part in the same direction as the mixed liquid.

6. A phase separation system comprising:
the phase separator according to claim 1; and
a mixed-liquid supply device that supplies the mixed liquid to the mutual contact space in the phase separator through the mixed-liquid introduction part.

7. A phase separation system comprising:
the phase separator according to claim 5;
a mixed-liquid supply device that supplies the mixed liquid to the mutual contact space in the phase separator through the mixed-liquid introduction part; and
a circulation-promoting-fluid supply device that supplies the circulation promoting fluid into the mutual contact space through the circulation-promoting-fluid introduction part in the phase separator.

8. The phase separation system according to claim 7, wherein: the introduction end of the partition member is the lower end of the partition member; the phase separator is configured to make the mixed liquid flow upward in the mutual contact space and transfer from the upper end of the partition member to the phase separation space and to make the liquid forming the first liquid phase transfer in the phase separation space to the mutual contact space; and the circulation-promoting-fluid supply device is configured to supply the second liquid or a fluid having a density smaller than the density of the second liquid to the circulation-promoting-fluid introduction part as the circulation promoting fluid.

9. The phase separation system according to claim 8, wherein the circulation-promoting-fluid supply device includes a second-liquid return device that returns the second liquid led out from the phase separator through the second lead-out part to the circulation-promoting-fluid introduction part of the phase separator as the circulation promoting fluid.

10. The phase separation system according to claim 8, wherein the circulation-promoting-fluid supply device is configured to supply a circulation promoting gas as the circulation promoting fluid to the circulation-promoting-fluid introduction part, and the phase separator further comprises a gas lead-out part located above the second lead-out part to allow the circulation promoting gas having risen in the mutual contact space to be led out of the phase separator through the gas lead-out part.

11. The phase separation system according to claim 7, wherein: the introduction end of the partition member is the upper end of the partition member; the phase separator is configured to make the mixed liquid flow downward in the mutual contact space and transfer from the lower end of the partition member to the phase separation space and to make the liquid forming the second liquid phase in the phase separation space transfer to the mutual contact space; and the circulation-promoting-fluid supply device is configured to supply the first liquid or a liquid having a density larger than the density of the first liquid to the circulation-promoting-fluid introduction part as the circulation promoting fluid.

12. The phase separation system according to claim 11, wherein the circulation-promoting-fluid supply device includes a first-liquid return device that returns the first liquid led out from the phase separator to the circulation-promoting-fluid introduction part of the phase separator as the circulation promoting fluid through the first lead-out part.

13. The phase separation system according to claim 6, wherein the mixed-liquid supply device includes an extractor that brings the first liquid and the second liquid into mutual contact to thereby allow an extraction target component included in one liquid of the first liquid and the second liquid to be extracted into the other liquid of the first liquid and the second liquid, the extractor being connected to the mixed-liquid introduction part so as to allow the mixed liquid discharged from the extractor and containing the first liquid and the second liquid to be supplied to the mutual contact space through the mixed-liquid introduction part.

14. A phase separation method for bringing a mixed liquid containing a first liquid and a second liquid into phase separation, the first liquid and the second liquid being capable of forming a first liquid phase and a second liquid phase, respectively, the first liquid being immiscible with the second liquid and having a specific gravity larger than a specific gravity of the second liquid, the method comprising:
providing a phase separator according to claim 1;
introducing the mixed liquid into the mutual contact space through the mixed-liquid introduction part to make the mixed liquid flow from the introduction end of the partition member of the phase separator to the discharge end that is an end opposite to the introduction end out of the upper end and the lower end of the partition member through the mutual contact space to thereby form a circulation flow of liquid involving a transfer of the mixed liquid discharged from the discharge end of the partition member to the phase separation space and a transfer of the liquid forming a liquid phase that is present at the height of the introduction end of the partition member out of the first liquid phase and the second liquid phase separated in the phase separation space to the mutual contact space;
leading out the first liquid forming the first liquid phase from the main body container through the first lead-out part; and
leading out the second liquid forming the second liquid phase from the main body container through the second lead-out part.

15. The phase separation method according to claim 14, wherein the phase separator further comprises a circulation-promoting-fluid introduction part for introducing a circulation promoting fluid having such a density that supply of the circulation promoting fluid into the mutual contact space increases a difference between a density of a fluid in the mutual contact space and a density of a liquid introduced into the mutual contact space from the phase separation space out of the first liquid and the second liquid to promote circulation of the liquid between the phase separation space and the mutual contact space, and wherein the circulation-promoting-fluid introduction part is disposed so as to allow the circulation promoting fluid to be introduced into the mutual contact space through the circulation-promoting-fluid introduction part in the same direction as the mixed liquid, the phase separation method further comprising supplying the circulation promoting fluid into the mutual contact space through the circulation-promoting-fluid introduction part to promote circulation of the liquid.

16. The phase separation system according to claim 6, wherein the partition member has a cylindrical shape extending vertically and enclosing the mutual contact space, and defines the phase separation space between an outer peripheral surface of the partition member and the main body container.

17. The phase separation system according to claim 6, wherein the lower end of the partition member is located above a container bottom surface, which is a bottom surface of the main body container, and the first lead-out part is located at a height position between the lower end of the partition member and the container bottom surface, the height position being a position to which the container bottom surface is closer than the lower end.

18. The phase separation system according to claim 6, wherein the upper end of the partition member is located below a container top surface of the container, which is a top surface of the main body container, and the second lead-out part is located at a height position between the upper end of the partition member and the container top surface of the container, the height position being a position to which the container top surface is closer than the upper end.
